(19) United States
(12) Patent Application Publication
(10) Pub. No.: US 2006/0171088 A1
(43) Pub. Date: Aug. 3, 2006

(54) Switching device with electronic current limiter

(75) Inventors: Sebastien Carcouet, Vif (FR); Thierry Boudet, Echirolles (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: Schneider Electric Industries SAS, Rueil-Malmaison (FR)

(21) Appl. No.: 11/330,206

(22) Filed: Jan. 12, 2006

(30) Foreign Application Priority Data
Jan. 18, 2005 (FR) 05 50137

(51) Int. Cl. H02H 3/08

(52) U.S. Cl. 361/93.1

(57) ABSTRACT

The present invention relates to a device (1) for switching current, for switching an electrical load (C) in an electrical power circuit, comprising at least one current switch (10, 10a, 10b, 10c, 10d, 10e) and characterized in that it also comprises an electronic current limiter (2) placed in series with the said current switch (10) and means (20) of control of the electronic current limiter (2) able to command the activation or the deactivation of the electronic current limiter (2). These means (20) of control exhibit the feature of being coupled to the current switch (10) so that, prior to any switching, the means (20) of control activate the electronic current limiter (2) so as to obtain during switching a current having a value below or equal to a determined threshold value.

### BACKGROUND OF THE INVENTION

1. Field of the Invention

The present invention pertains to a device for switching current associating at least one current switch and one electronic current limiter.

2. Description of the Prior Art

With the aim of preserving the contacts of a current switch, it is known that, during the opening or the closing of the current switch, it is necessary to avoid the inception of an electric arc between the contacts so as to limit the wearing of the contacts of the current switch and to consequently increase the lifetime of the device. It is known for example from document DE 195 30 494 to use an electronic current limiter in a circuit breaker. In a circuit breaker, the limitation of the current is achieved automatically when a certain threshold of current is exceeded. Furthermore, the cue to open the contacts of the switch not being foreseeable, it is impossible to limit the current during the opening of the contacts.

### SUMMARY OF THE INVENTION

The aim of the invention is to propose a device for switching current in which the opening or the closing of a switch is effected on command without the occurrence of an electric arc.

This aim is achieved through a device for switching current comprising at least one current switch for switching an electrical load in an electrical power circuit and characterized in that it also comprises an electronic current limiter placed in series with the said current switch and means of control of the electronic current limiter able to command the activation or the deactivation of the electronic current limiter, these means of control being coupled to the current switch so that the means of control activate the electronic current limiter so as to obtain during switching of the switch a current having a value below or equal to a determined threshold value.

In the case of a contactor with current limiter, the switching is thus carried out once the current is limited to a value below that at which an electric arc occurs. Once the switching has been performed, the means of control deactivate the electronic current limiter, this being manifested through a decrease in its resistance and this making it possible to re-establish the normal current in the electrical circuit. By thus limiting the current, the wearing of the contacts of the current switch is reduced and the lifetime of the device is consequently increased.

According to the invention, the means of control coordinate the activation or the deactivation of the current limiter and the switching of the current switch so as to limit the current to a value below that at which an electric arc occurs during the opening or the closing of the current switch. Depending on the case, this coordination is achieved automatically by dint of the respective response times of the current limiter and of the current switch or by the use of a timer for example integrated into the control means.

According to a feature of the invention, the timer of the control means is set to a determined duration corresponding to an interval time of between the dispatch of an activation command to the electronic current limiter and the dispatch of a switching command to the current switch. A time lag with the aid of such a timer can also make it possible to maintain the activation of the current limiter until the opening and closing operations have been completed since non-compliance with this procedure would bring about damage to the current switch.

According to another feature, the threshold value is substantially equal to zero. The electronic current limiter is thus used in breaker mode.

According to another feature, the electronic current limiter is fabricated from a substrate suitable for power electronics, that is to say suitable for being integrated into a circuit for supplying an electrical load.

According to another feature, the substrate of the electronic current limiter is made of silicon.

According to another feature, the substrate of the electronic current limiter is made of silicon carbide. Silicon carbide may be used in preference to silicon if the electronic current limiter is to be integrated into a microsystem and if the nominal voltage is greater than 400 Vac.

According to the invention, given that the electric circuit is supplied with alternating current, the electronic current limiter has to be bidirectional in terms of current and voltage. A JFET component which is unidirectional may therefore not be used just as it is as the electronic current limiter in the device according to the invention. According to the invention, the electronic current limiter therefore exhibits a structure produced for example on the basis of a JFET made of silicon or of silicon carbide so as to address the requirements of the invention.

In the case where one wishes to use a JFET component without modification, it has to be integrated for example at the centre of a diode bridge or be associated with another JFET component in parallel and with diodes.

According to another feature, the current switch is fabricated according to a technology of microsystems type (micromechanics or MEMS or association of MEMS and micromechanics).

According to another feature, the current switch fabricated according to a technology of microsystems type and the electronic current limiter fabricated from silicon carbide are integrated into one and the same component.

According to a particular embodiment, the device comprises a plurality of current switches disposed in parallel and coupled to the means of control of the electronic current limiter.

According to another feature, upon the closing of the current switch, the use of such an electronic current limiter also makes it possible to alleviate the drawback related to possible chatter of the current switch.

According to the invention, the current switch provides for galvanic isolation and exhibits a low resistance in the on state in the nominal regime. On the other hand, it is not dimensioned to provide solely for the cutoff of the nominal current. The use of an electronic current limiter to avoid the occurrence of electric arcs is necessary.

### BRIEF DESCRIPTION OF THE DRAWINGS

Other characteristics and advantages will become apparent in the detailed description which follows while referring to an embodiment given by way of example and represented by the appended drawings in which:

FIG. 1 represents a switching device according to the invention comprising several current switches disposed in parallel.

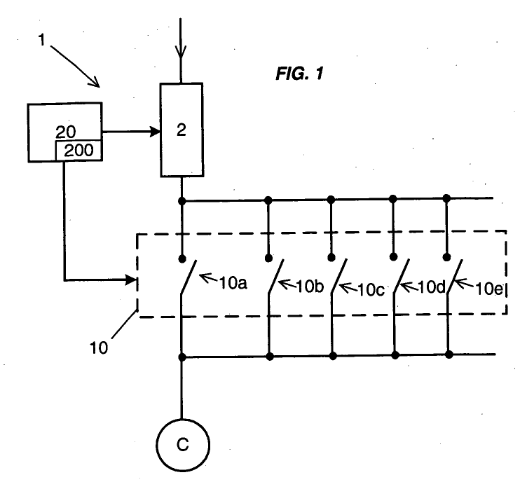

### DESCRIPTION OF THE PREFERRED EMBODIMENTS

The invention pertains to a device 1 for switching a load C. This switching device 1 uses an electronic current limiter 2 making it possible to avoid the occurrence of an electric arc upon the opening or the closing of a current switch placed in the electrical power circuit for supplying the load C with alternating current. Thus the electronic current limiter 2 enables the current switch to be fed only with a current lower than a determined threshold value substantially equal to the value of current at which an electric arc occurs. When the contacts of a switch are made of gold, the current at which an electric arc occurs is approximately 0.3 ampere. In this case, it will therefore suffice to limit the current bound for the current switch to a value of lower than 0.3 ampere.

Before the opening of the switch, the simple limitation of the current to a nonzero value below the value at which an electric arc occurs is sufficient when the electrical load to be supplied is resistive. On the other hand, when the load is inductive, it is necessary to turn off the electronic current limiter 2 so as to completely cut off the current in the electrical power circuit and thus avoid overvoltages across the terminals of the switch when it is opened.

The current switching device 1 can comprise on the electrical power circuit, one or more current switches (10, 10a, 10b, 10c, 10d, 10e) disposed in parallel and placed in series with an electronic current limiter 2. In the electrical power circuit, the electronic current limiter 2 is placed upstream of the current switches 10. The setting of the electronic current limiter is adjusted in such a way as to allow through, once activated, only a current having a value below a determined threshold value, substantially equal to that at which an electric arc occurs in the current switch or switches 10 with which it is associated.

The switching device 1 comprises means 20 of control of the electronic current limiter 2. These means 20 of control of the electronic current limiter command the activation or the deactivation of the electronic current limiter 2. These means 20 of control have the feature of being coupled to the current switches 10. Specifically, when a command to open or close the contacts is dispatched, for example by a user, a signal is received by the control means 20 which before or simultaneously with the transmission of this command to the current switches 10, dispatch an activation command to the electronic current limiter 2 placed upstream of the current switches 10. The activation of the electronic current limiter 2 is manifested through an increase in its resistance so as to limit the current flowing towards the current switches 10. The electronic current limiter 2 thus limits the current to a value which, depending on the nature of the load, resistive or inductive, is zero or non-zero and in both cases below that at which an electric arc occurs in the current switches 10. Depending on the case, the dispatching of the activation command to the electronic current limiter 2 and the dispatching of the switching command to the current switches 10 may therefore be, in a first variant, simultaneous, or in a second variant, deferred.

In the first variant where the dispatching of the activation command to the electronic current limiter 2 is simultaneous with the dispatching of the switching command to the current switch 10, it is the respective response times between the current switches 10 and the electronic current limiter 2 which make it possible to obtain limitation of the current during switching. The response time of the current switches 10 is then less than the response time of the electronic current limiter 2. The activation of the electronic current limiter 2 therefore takes place before the switching of the current switches 10.

In the second variant, a time lag between the dispatching of the two commands is used. After the dispatching of the activation command to the electronic current limiter 2 and after a determined duration, the switching command is dispatched to the current switches 10. The control means 20 can comprise for example a timer 200 set to a determined duration after which they are responsible for dispatching the switching command to the current switches 10. Upon the opening or the closing of the current switches 10, the current bound for the current switches 10 is maintained by the electronic current limiter 2 at a value below that of the current at which an electric arc occurs, thereby making it possible to avoid the occurrence of an electric arc and therefore to avoid premature wearing of the contacts of the current switches 10. Subsequently, after the elapsing of a determined duration, corresponding for example to the duration of opening or of closing of the current switches 10, set for example, in the timer 200, the means 20 of control of the electronic current limiter 2 dispatch a deactivation command to the electronic current limiter 2 so as to deactivate it. This is manifested at the level of the electronic current limiter 2 by a reduction in its electrical resistance and hence by a re-establishing of the normal current bound for the current switches 10.

The current switches 10 may be fabricated in a conventional electromechanics type technology. According to a variant embodiment, these current switches 10 may be fabricated in a technology of microsystems type (micromechanics or MEMS or association of MEMS and micromechanics). The contacts of the current switches 10 fabricated in a technology of microsystems type have a small thickness and surface area. In order to preserve these contact surfaces, it is therefore indispensable to open and close the current switches without the occurrence of an electric arc.

According to the invention, the electronic current limiter 2 is fabricated in a substrate suitable for power electronics, that is to say suitable for integration into a circuit for supplying an electrical load, and will, for example be produced on the basis of a JFET (junction field effect transistor) made of silicon (Si) or preferably of silicon carbide (SiC) if the nominal voltage is greater than 400 Vac and if the electronic current limiter 2 is to be integrated into a microsystem. Silicon carbide exhibits the advantage in particular of having a small chip size and low resistance in the on state, thereby making it possible to limit thermal dissipations. Limiting thermal dissipations in the electronic current limiter 2 is all the more important when the switches are of small size (for example using MEMS technology), since they exhibit resistive behaviour in the closed state. Once deactivated, the electronic current limiter 2 is designed to have a minimum resistance so as not to disturb the entry of the current into the load C when the switch 10 is closed. Other materials such as diamond, boron nitride (BN), aluminium nitride (AlN) or gallium nitride (GaN) are also perfectly suitable for power electronics.

An electronic current limiter 2 made of silicon carbide exhibiting a surface area of less than 10 mm² is able to limit the current for example to 1/10^{th} of its nominal value.

A current limiter produced from silicon carbide, for example on the basis of a JFET, exhibits for example the following electrical specifications:
Nominal voltage=400 Vac
Nominal current strength=2 Arms
Resistance of the limiter Rp in the on state, that is to say deactivated<to 100 mΩ
Surface area of the current limiter component made of SiC<10 mm².

On the basis of this example, to obtain a determined threshold value equal, for example to 0.2 A (for contacts made of gold), the resistance Rb of the activated limiter will therefore have to be at least 2800Ω (400√2/0.2=2828Ω).

It would in particular be conceivable to integrate the electronic current limiter 2 fabricated for example on the basis of a JFET made of silicon carbide and one or more current switches 10 fabricated according to a technology of microsystems type into one and the same component.

According to a particular embodiment, so as to be able to perform the current limitation desired as a function of the type of current switch used, the means of control of the electronic current limiter are able to vary the resistance of the limiter, for example according to a determined ramp.

As described previously, according to a particular embodiment, it may also be conceivable to completely cancel the current, before the opening of the current switch, by turning off the electronic current limiter 2. This amounts to using the electronic current limiter 2 in breaker mode or as a diode. The switch 10 then serves to separate the contacts so as to obtain a sufficient insulation distance. Placing the electronic current limiter in an off state is necessary when the load is inductive.

It is of course understood that it is possible, without departing from the scope of the invention, to envisage other variants and refinements of detail and even to conceive of the use of equivalent means.

1. Device for switching current comprising at least one current switch for switching an electrical load in an A.C. electrical power circuit and wherein it also comprises an electronic current limiter placed in series with the said current switch and means of control of the electronic current limiter able to command the activation or the deactivation of the electronic current limiter, these means of control being coupled to the current switch so that the means of control activate the electronic current limiter so as to obtain during switching of the switch a current having a value below or equal to a determined threshold value.

2. Device according to claim 1, wherein the means of control are able to simultaneously dispatch an activation command to the electronic current limiter and a switching command to the current switch.

3. Device according to claim 1, wherein the means of control are able to dispatch a switching command to the current switch deferred with respect to a dispatch of a command for activation of the electronic current limiter.

4. Device according to claim 3, wherein the means of control comprise a timer of a determined duration corresponding to an interval of time between the dispatch of the activation command to the electronic current limiter and the dispatch of the switching command to the current switch.

5. Device according to one of claims 1 to 4, wherein the means of control are able to dispatch a deactivation command to the electronic current limiter after a determined duration set in a timer.

6. Device according to one of claims 1 to 5, wherein the threshold value is substantially equal to zero.

7. Device according to one of claims 1 to 6, wherein the electronic current limiter is fabricated from a substrate suitable for power electronics.

8. Device according to claim 7, wherein the substrate is made of silicon.

9. Device according to claim 7, wherein the substrate is made of silicon carbide.

10. Device according to claim 9, wherein the electronic current limiter is produced on the basis of a JFET made of silicon carbide.

11. Device according to one of claims 1 to 10, wherein the current switch is fabricated according to a technology of microsystems type.

12. Device according to claim 1, wherein the current switch fabricated according to a technology of microsystems type and the electronic current limiter fabricated from silicon carbide are integrated into one and the same component.

13. Device according to one of claims 1 to 12, wherein it comprises a plurality of current switches disposed in parallel and coupled to the means of control of the electronic current limiter.
